(19) United States
(12) Patent Application Publication
(10) Pub. No.: US 2007/0223617 A1
(43) Pub. Date: Sep. 27, 2007

(54) MULTI-PORT-BASED MIMO ANTENNA RECEIVER

(75) Inventors: Sang Yub LEE, GYUNGGI-DO (KR); Hak Sun KIM, DAEJEON (KR); Chang Soo YANG, GYUNGGI-DO (KR); Jeong Suk LEE, GYUNGGI-DO (KR); Wan Chul YANG, GYUNGGI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/689,076

(22) Filed: Mar. 21, 2007

(30) Foreign Application Priority Data
Mar. 24, 2006 (KR) 10-2006-0027152

(51) Int. Cl. H04L 1/02

(52) U.S. Cl. 375/267

(57) ABSTRACT

An multi-port based MIMO antenna receiver is designed to remove signal interferences occurring among MIMO antennas in the use. In the MIMO antenna receiver, a multi-port unit is connected to MIMO antennas, and a signal interference remover receives receipt signals from the MIMO antennas through the multi-port unit and adds each of the receipt signals with another one of the receipt signals to which preset weight values for minimizing signal interference are multiplied in order to remove interferences from the receipt signals. A phase converter converts the signals from the signal interference remover into multi-phase signals of different phases. A signal detector detects I and Q signals from the multi-phase signals converted by the phase converter. A signal processor restores original data by using the I and Q signals detected by the phase converter, and a weight value calculator monitors the detection signals by the signal detector while calculating a weight value of each of the receipt signals with the detection signal corresponding to an optimum receiving condition.

### CLAIM OF PRIORITY

This application claims the benefit of Korean Patent Application No. 2006-27152 filed on Mar. 24, 2006, in the Korean Intellectual Property Office, the disclosure of which is incorporated herein by reference.

### BACKGROUND OF THE INVENTION

1. Field of the Invention

The present invention relates to a multi-port based Multiple-Input Multiple-Output (MIMO) antenna receiver applicable to a frequency environment having a high bandwidth such as super high frequency, more particularly, which is designed to remove signal interferences occurring among MIMO antennas during the use of the MIMO antennas in order to reduce errors in signal processing through the MIMO antennas, easily obtain a compact structure, improve signal-receiving performance, and directly detect and determine receipt signals without specific procedures of comparing and determining signals.

2. Description of the Related Art

In general, the amount of data which a radio communication system can transmit via each channel is limited to a specific amount according to channel characteristics. In case of attempting to transmit a massive amount of data, a large number of channels should be used for transmission.

In a communication method using such multiple channels, there is an MIMO antenna transmitting/receiving system which has a number of antennas to simultaneously transmit and receive different data through the respective antennas.

The MIMO antenna transmitting/receiving system based on multiple ports does not change all RF components in response to every change in frequency environment but can be adapted to all frequency changes through a simple multi-port receiver. Furthermore, the number of components can be reduced than conventional other receiver systems. Accordingly, the MIMO antenna system can be compact-sized further.

The multi-port receiver system is a frequency direct conversion receiver, which detects a baseband signal by direct conversion from super radio frequency without using intermediate frequency. The multi-port receiver system adopting the direct conversion method can advantageously omit devices such as an IF filter for intermediate frequency conversion. Furthermore, since a baseband signal can be directly detected from a receipt signal, the multi-port receiver system can implement direct signal mapping and thus does not need a decision procedure for mapping.

FIG. 1 is a configuration diagram illustrating a conventional MIMO antenna transmission and receiving system.

Referring to FIG. 1, the conventional MIMO antenna transmission and receiving system includes an MIMO antenna transmitter 10 for transmitting transmission signals through multiple antenna paths and an MIMO antenna receiver 20 for receiving the signals from the MIMO antenna transmitter 10 through the multiple antenna paths.

The conventional MIMO antenna transmission and receiving system includes a plurality of antennas, which should be spaced from one another at a specific distance to reduce mutual interferences.

If a sufficient distance is not ensured among the antennas, interferences occur among the antennas and thus performance is degraded.

The antennas spaced from one another to ensure a mutual distance disadvantageously increases the size of the MIMO antenna transmitting/receiving system. However, there is no effective method to reduce mutual interference of the antennas in the conventional MIMO antenna transmitting/receiving system.

As an approach to improve performance by reducing the system size but excluding signal interferences, it is required to research and develop means for excluding signal interferences which is applicable to the MIMO antenna transmitting/receiving system.

### SUMMARY OF THE INVENTION

The present invention has been made to solve the foregoing problems of the prior art and therefore an aspect of certain embodiments of the present invention is to provide a multi-port based MIMO antenna receiver which is designed to remove signal interferences occurring among MIMO antennas during the use of the MIMO antennas in order to reduce errors in signal processing through the MIMO antennas, easily obtain a compact structure, improve signal-receiving performance, and directly detect and determine receipt signals without specific procedures of comparing and determining signals.

According to an aspect of the invention for realizing the object, the invention provides a multi-port based MIMO antenna receiver including a multi-port unit connected to a plurality of MIMO antennas; a signal interference remover for receiving a plurality of receipt signals from the MIMO antennas through the multi-port unit and adding each of the receipt signals with another one of the receipt signals to which preset weight values for minimizing signal interference are multiplied in order to remove interferences from the receipt signals; a phase converter for converting the signals from the signal interference remover into multi-phase signals of different phases; a signal detector for detecting I and Q signals from the multi-phase signals converted by the phase converter; a signal processor for restoring original data by using the I and Q signals detected by the phase converter; and a weight value calculator for monitoring the detection signals by the signal detector while calculating a weight value of each of the receipt signals with the detection signal corresponding to an optimum receiving condition.

Preferably, the signal interference remover includes: a multiplier for multiplying the weight value of each of the receipt signals calculated by the weight calculator with another ones of the receipt signals; and an adder for adding the each receipt signal with the multiplied signals.

Preferably, the phase converter includes: filters for passing the signals from the signal interference remover through preset bands, respectively, amplifiers for amplifying the signals received from the filter by preset gains, respectively; and signal converters for converting the signals from the amplifier into a plurality of multi-phase signals of different phases.

Preferably, the signal converter includes: a reference signal generator for generating a reference signal; a phase shifter for shifting the reference signal from the reference signal generator by different phases to generate a plurality of reference signals of the different phases; a gain controller for controlling gains of the reference signals received from the phase shifter; and an adder for adding the reference signals from the gain controller respectively with the receipt signals from the amplifier.

Preferably, the signal converter includes: a reference signal generator for generating a reference signal; a phase shifter for shifting the reference signal from the reference signal generator by different phases to generate first to fourth reference signals of the different phases; a gain controller for controlling the first to fourth reference signals received from the phase shifter by different gains; and an adder for adding the first to fourth reference signals received from the gain controller with respective first to fourth receipt signals received from the amplifier, in which the receipt signals are divided respectively, to generate first to fourth phase signals and providing a plurality of multi-phase signals including the first to fourth phase signals.

Also preferably, the signal detector includes: a squarer for squaring the first to fourth phase signals of the multi-phase signals from the signal converter; a base filter for passing the first to fourth phase signals of the multi-phase signals from the squarer through preset baseband signal bandwidths; and an adder for adding the first and second phase signals of the multi-phase signals received from the baseband filter to produce an I receipt signal and adding the third and fourth phase signals of the multi-phase signals received from the baseband filter to produce a Q receipt signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram illustrating a conventional MIMO antenna transmission and receiving system;

FIG. 2 is a configuration diagram illustrating an MIMO antenna transmission and receiving system of the invention;

FIG. 3 is a configuration view illustrating the signal interference remover shown in FIG. 2;

FIG. 4 is a configuration view illustrating the phase converter and the signal detector shown in FIG. 3;

FIG. 5 is a configuration view illustrating the signal converter shown in FIG. 4; and

FIG. 6 is a graph illustrating SER-SNR characteristics of the MIMO antenna receiver of the invention.

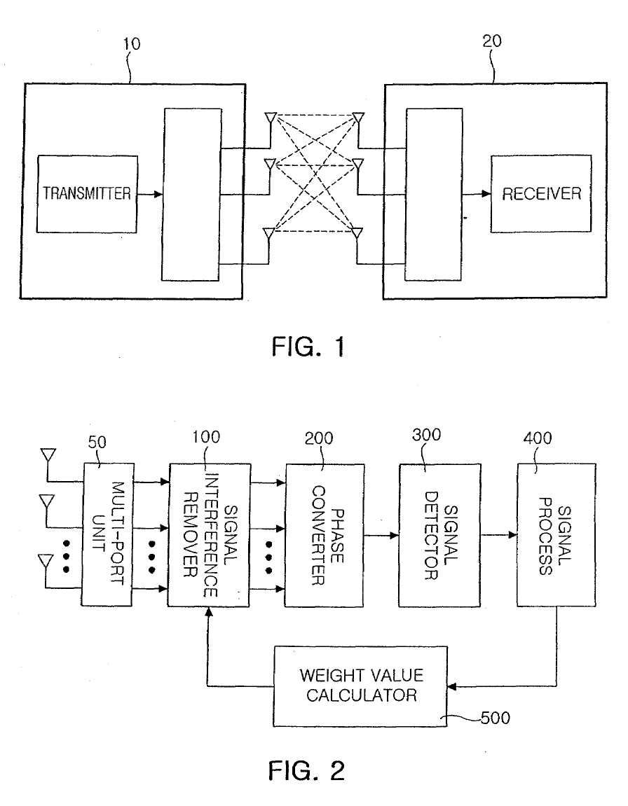

### DETAILED DESCRIPTION OF THE PREFERRED EMBODIMENT

Preferred embodiments of the present invention will now be described more fully hereinafter with reference to the accompanying drawings, in which the same reference signs are used to designate the same or similar components throughout.

Referring to FIG. 2, an MIMO antenna receiver of the invention includes a multi-port unit 50, a signal interference remover 100, a phase converter 200, a signal detector 300, a signal processor 400 and a weight value calculator 500. The multi-port unit 50 is connected to a plurality of MIMO antennas ANT1 to ANTn. The signal interference remover 100 receives a plurality of receipt signals from the MIMO antennas ANT1 to ANTn through the multi-port unit 50 and adds each of the receipt signals with another one of the receipt signals to which preset weight values for minimizing signal interference are multiplied in order to remove interferences from the receipt signals. The phase converter 200 acts to covert the signals from the signal interference remover 100 into multi-phase signals of different phases. The signal detector 300 acts to detect I and Q signals out of the multi-phase signals which are converted by the phase converter 200. The signal processor 400 restores original data by using the I and Q signals detected by the phase converter 200. The weight value calculator 500 monitors the detection signals by the signal detector 300 while calculating a weight value of each of the receipt signals with the detection signal corresponding to an optimum receiving condition.

The MIMO antennas ANT1 to ANTn are connected to the signal interference remover 100 via the multi-port unit 50.

For example, when the MIMO antenna receiver of the invention includes four (4) MIMO antennas ANT1 to ANTn for having first to fourth receipt signals, the weight value calculator 500 provides first to fourth weight values for the first to fourth receipt signals, respectively.

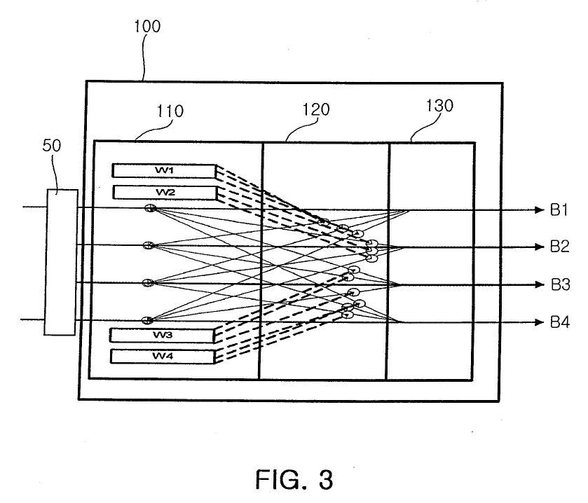

FIG. 3 is a configuration view illustrating the signal interference remover shown in FIG. 2.

Referring to FIG. 3, the signal interference remover 100 includes a multiplier 110 for multiplying the weight value of each of the receipt signals calculated by the weight calculator 500 with another ones of the receipt signals and an adder 120 for adding the each receipt signal with the multiplied signals.

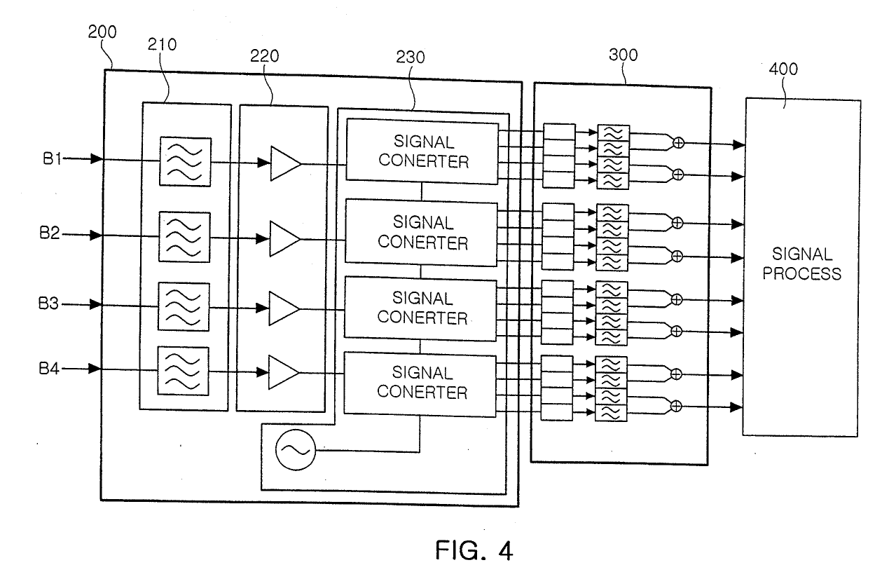

FIG. 4 is a configuration view of the phase converter 200 and the signal detector 300 shown in FIG. 3.

Referring to FIG. 4, the phase converter 200 includes filters 210 for passing the signals from the signal interference remover 100 through preset bands, respectively, amplifiers 220 for amplifying the signals received from the filter 210 by preset gains, respectively, and signal converters 230 for converting the signals from the amplifier 220 into a plurality of multi-phase signals of different phases.

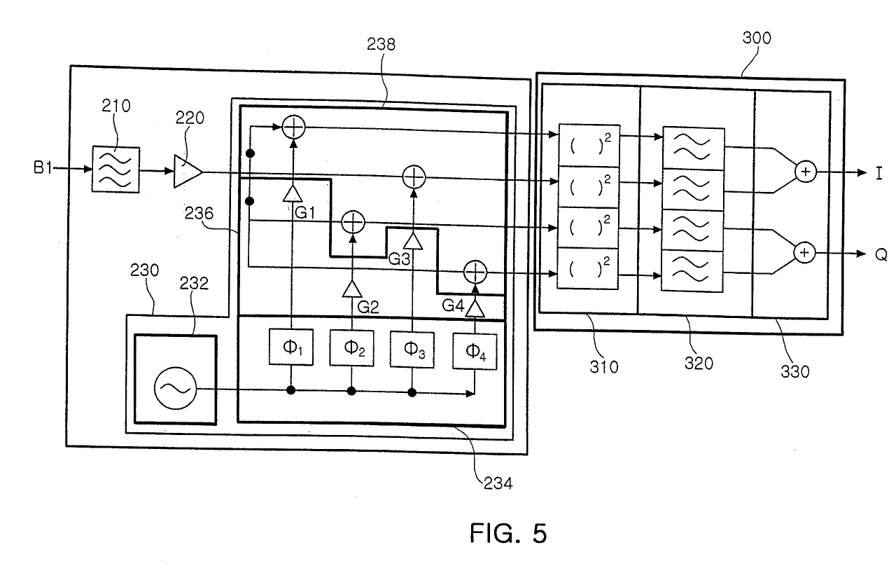

FIG. 5 is a configuration view of the signal converter 230 shown in FIG. 4.

Referring to FIG. 5, the signal converter 230 includes a reference signal generator 232 for generating a reference signal, a phase shifter 234 for shifting the reference signal from the reference signal generator 232 by different phases to generate a plurality of reference signals of the different phases, a gain controller 236 for controlling gains of the reference signals received from the phase shifter 234 and an adder 238 for adding the reference signals from the gain controller 236 respectively with the receipt signals from the amplifier 220.

In addition, describing the signal shifter 230 in more detail as an example with reference to FIG. 5, the reference signal generator 232 acts to generate a reference signal, the phase shifter 234 acts to shift the reference signal received from the reference signal generator 232 by different phases of 0, 90, 180 and 270 degrees thereby producing first to fourth reference signals of the different phases. The gain controller 236 acts to control the first to fourth reference signals received from the phase shifter 234 by different gains G1 to G4, and the adder 238 acts to add the first to fourth reference signals received from the gain controller 236 with respective first to fourth receipt signals received from the amplifier 220, in which the receipt signals are divided respectively, to generate first to fourth phase signals and thus to provide a plurality of multi-phase signals including the first to fourth phase signals.

The signal detector 300 includes a squarer 310 for squaring the first to fourth phase signals of the multi-phase signals from the signal converter 230, a base filter 320 for passing the first to fourth phase signals of the multi-phase signals from the squarer 310 through preset baseband signal bandwidths and an adder 330 for adding the first and second phase signals of the multi-phase signals received from the baseband filter 320 to produce an I receipt signal and adding the third and fourth phase signals of the multi-phase signals received from the baseband filter 320 to produce a Q receipt signal.

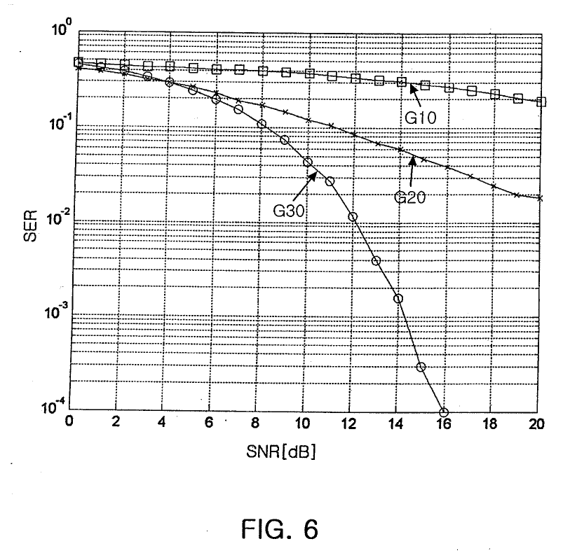

FIG. 6 is a graph illustrating SER-SNR characteristics of the MIMO antenna receiver of the invention. Referring to FIG. 6, G10 is SER-SNR characteristics graph in a conventional MIMO antenna receiver according to Minimum Least (ML) technique, G20 is SER-SNR characteristics graph in a conventional MIMO antenna receiver according to Minimum Mean Square Error (MMSE) technique, and G30 is SER-SNR characteristics graph in the MIMO antenna receiver of the invention.

Hereinafter the operations and effects of the invention will be described in detail in conjunction with the accompanying drawings.

The multi-port based MIMI antenna receiver of the invention can remove signal interferences in a plurality of MIMO antennas to reduce errors in signal processing and facilitate the miniaturization of the antennas, thereby improving receiving performance. Such characteristics and merits will be described with reference to FIGS. 2 to 6.

First, the MIMO antenna receiver of the invention will be described with reference to FIG. 2.

Referring to FIG. 2, the MIMO antenna receiver of the invention includes the multi-port unit 50, the signal interference remover 100, the phase converter 200, the signal detector 300, the signal processor 400 and the weight value calculator 500.

The multi-port unit 50 can act to connect the plurality of MIMO antennas ANT1 to ANTn to the signal interference remover 100 so as to discriminate respective receipt signals inputted from the respective MIMO antennas.

The signal interference remover 10 receives the receipt signals from the MIMO antennas connected to the multi-port unit 50, and adds each of the respective receipt signals with another one of the receipt signals to which preset weight values for minimizing signal interference are multiplied.

Through this process, the signal interference remover 100 can remove interferences from the receipt signals.

The phase converter 200 acts to convert the signals received from the signal interference remover 100 into multi-phase signals of different phases. For example, any one of the receipt signals can be converted into four signals of different phases by reference signals of 0, 90, 180 and 270 degree phases.

The signal detector 300 acts to detect orthogonal I and Q signals for each of the receipt signals or multi-phase signals received from the phase converter 200, in which the I and Q signals have a phase difference of 90 degree.

The signal processor 400 acts to restore original data by using the I and Q signals for each of the receipt signals received from the signal detector 300.

Then, the weight value calculator 500 monitors the detection signals by the signal detector 300 while calculating a weight value of each of the receipt signals with the detection signal corresponding to an optimum receiving condition. The weight value calculator 500 outputs the weight value to the signal interference remover 100.

For example, in a case where the MIMO antenna receiver of the invention includes four (4) MIMO antennas ANT1 to ANT4, the weight value calculator 500 provides first to fourth weight values W1 to W4 for first to fourth receipt signals received through the four MIMO antennas ANT1 to ANT4.

The weight value calculator 500 produces the weight values of the respective receipt signals according to Equation1 below:

W_{i,j}(n+1)=W_{i,j}(n)−μe_{i,j}(n)bⱼ(n) Equation 1,

where e_{i,j}(n) is obtained by Equation 2 below, and bⱼ(n) is obtained by Equation 3 below, and W_{i,j}(n) is obtained by Equation 4 below:

$$\begin{matrix}{e}_{i , j} = {b}_{j} ( n ) - Sj ( n ) … , M , i \neq j ] , & Equation 2 \\ b ( t ) = {Wk}^{- 1} y ( t ) = {Wk}^{- 1} [ Hx ( t ) - n ( t ) ] \neq j ] , \\ and \\ Wk [ k = 1 , 2 , 3 , 4 ] = [ \begin{matrix}1 & - W 12 & - W 13 & - W 14 \\ - W 21 & 1 & - W 23 & - W 24 \\ - W 31 & - W 32 & 1 & - W 34 \\ - W 41 & - W 42 & - W 43 & 1\end{matrix} ] & Equation 3 \\ [ i , j = 1 , 2 , 3 , … , M , i \neq j ] , & Equation 4\end{matrix}$$

where Sj(n) is one of four signals which are previously known in OPSK technique, and y(t) in Equation 3 above is a receipt signal.

As seen in Equations 1 to 4 above, Wk is obtained by Equation 4, b(t) is obtained by Equation 3, e_{i,j}(n) is obtained by Equation 2, and then weight values W1 to W4 for the respective receipt signals are obtained by Equation 1.

The signal interference remover 100 will now be described with reference to FIG. 3.

Referring to FIG. 3, in a case where the signal interference remover 100 includes the multiplier 110 and the adder 120, the multiplier 110 multiplies the weight value of each of the respective signals, received from the weight value calculator 500, to another one of the respective signals and outputs the resultant signals to the adder 120. The adder 120 adds the respective signals received from the multiplier 110 with those multiplied with the weight value.

In this process, the weight value of the each signal corresponds to the optimum receiving condition for each antenna, and thus the signal interference of the antennas can be maintained minimally.

The phase converter 200 will now be described with reference to FIG. 4.

Referring to FIG. 4, in a case where the phase converter 200 includes the filters 210, the amplifiers 220 and the signal converters 230, the filters 210 pass the respective signals, received from the signal interference remover 100, through preset bands and output the filtered signals to the amplifiers 220.

The amplifiers 220 amplify the respective signals, received from the filters 210, to preset gains and output the amplified signals to the signal converters 230.

The signal converters 230 convert the respective signals, received from the amplifiers 220, into a plurality of multi-phase signals of different phases.

The signal converter 230 will now be described with reference to FIG. 5.

Referring to FIG. 5, in a case where the signal converter 230 includes the reference signal generator 232, the phase shifter 234, the gain controller 236 and the adder 238, the reference signal generator 232 generates a reference signal of a preset frequency (e.g., 3 GHz) and outputs this reference signal to the phase shifter 234.

The phase shifter 234 shifts the reference signal, received from the reference signal generator 232, by different phases to generate a plurality of reference signals of different phases and outputs these reference signals to the gain controller 236. This is because the reference signals of four (4) different phases are required for the acquirement of I and Q signals.

The gain controller 236 controls the gain of the respective reference signals, received from the phase converter 234, and outputs the gain-controlled reference signals to the adder 238. This is because the reference signals of four different phases are also required to have different magnitudes for the acquirement of the I and Q signals.

The adder 238 adds the reference signals received from the gain controller 236 with the respective receipt signals received from the amplifier 220.

For example, in a case where the phase converter 234 generates first to fourth reference signals by shifting the reference signal, received from the reference signal generator 232, by 0, 90, 180 and 270 degree phases, the gain controller 236 can control the first to fourth reference signals, received from the phase shifter 234, by different gains. The adder 238 adds the first to fourth reference signals, received from the gain controller 236, with the first to fourth signals, in which the receipt signals are divided respectively, to generate first to fourth phase signals and provide a plurality of multi-phase signals including the first to fourth phase signals.

In this process, in order to detect the I and Q signals by QPSK technique, the respective receipt signals are divided into four signals and the divided signals are added respective with signals of different phases.

The signal detector 300 will now be described with reference to FIG. 5.

Referring to FIG. 5, in a case where the signal detector 300 includes the multiplier 310, the baseband filter 320 and the adder 330, the multiplier 310 of the signal detector 300 squares the first to fourth phase signals of the respective phase signals, received from the signal converter 230, and outputs the squared signals to the baseband filter 320 in order to adjust carrier frequency down to a baseband.

The baseband filter 320 passes the first to fourth phase signals of the respective multi-phase signals, received from the squarer 310, and outputs the filtered signals to the adder 330.

In this case, the adder 330 adds the first and second phase signals of the respective multi-phase signals, received from the baseband filter 320, into an I receipt signal, and adds the third and fourth phase signals of the respective multi-phase signals, received from the baseband filter 320, into a Q receipt signal.

In the meantime, the multi-port based MIMO antenna receiver of the invention, if adopting QPSK technique as reported in Table 1 below, can advantageously determine a transmission signal based on a voltage detected in the multi-port unit.

Table 1 below shows that a voltage ratio detected at each output port can be used to immediately determine which signal has been transmitted at a transmitting point. That is, the transmission signal can be determined and mapped based on the port detection value without a specific constellation or decision stage.

For example, in a case where four MIMO antennas ANT1 to ANT4 connected to a receiving port unit having four ports detect voltages V1 to V4, respectively, receipt signals can be determined according to the respective port voltages of transmission signals as reported in Table 1 below:

TABLE 1

| Transmission | | | | | |
|---|---|---|---|---|---|
| (TX) | V1 | V2 | V3 | V4 | RX |
| 11 | Min | — | — | — | 11 |
| 01 | — | Min | — | — | 01 |
| 00 | — | — | Min | — | 00 |
| 10 | — | — | — | Min | 10 |

As the largest advantage of the multi-port unit, even though carrier frequency is changed in an existing receiver, all device values and filter characteristics are not required to be changed. That is, the use of the multi-port unit can detect a transmission signal as it is regardless of the carrier wave of the transmission signal even if the carrier wave is changed.

Referring to FIG. 6, the performance of the multi-port based MIMO antenna receiver of the invention will be explained in comparison with those of existing receivers.

In FIG. 6, G10 is SER-SNR characteristics graph in a conventional MIMO antenna receiver according to Minimum Least (ML) technique, G20 is SER-SNR characteristics graph in a conventional MIMO antenna receiver according to Minimum Mean Square Error (MMSE) technique, and G30 is SER-SNR characteristics graph in the MIMO antenna receiver of the invention.

Comparing the graphs G10, G20 and G30 shown in FIG. 6 together, the graph G30 of the MIMO antenna receiver of the invention shows the lowest Symbol Error Rate (SER) in the same Signal-to-Noise Ratio (SNR) relative to the graphs G10 and G20 of the conventional receivers. It can be seen that the difference increases gradually as SNR approaches 16.

Accordingly, it is appreciated that symbol error rate is generally lowered in the MIMO antenna receiver of the invention than in the conventional receivers.

According to the invention as described above, in the multi-port based MIMO antenna receiver applicable to a frequency environment having a high bandwidth such as super high frequency, it is possible to remove signal interferences occurring among MIMO antennas during the use of the MIMO antennas in order to reduce errors in signal processing through the MIMO antennas, easily obtain a compact structure, improve signal-receiving performance, and directly detect and determine receipt signals without specific procedures of comparing and determining signals.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

What is claimed is:

1. A multi-port based multiple-input multiple-output (MIMO) antenna receiver comprising:
a multi-port unit connected to a plurality of MIMO antennas;
a signal interference remover for receiving a plurality of receipt signals from the MIMO antennas through the multi-port unit and adding each of the receipt signals with another one of the receipt signals to which preset weight values for minimizing signal interference are multiplied in order to remove interferences from the receipt signals;
a phase converter for converting the signals from the signal interference remover into multi-phase signals of different phases;
a signal detector for detecting I and Q signals from the multi-phase signals converted by the phase converter;
a signal processor for restoring original data by using the I and Q signals detected by the phase converter; and
a weight value calculator for monitoring the detection signals by the signal detector while calculating a weight value of each of the receipt signals with the detection signal corresponding to an optimum receiving condition.

2. The antenna receiver according to claim 1, wherein the signal interference remover includes:
a multiplier for multiplying the weight value of each of the receipt signals calculated by the weight calculator with another ones of the receipt signals; and
an adder for adding the each receipt signal with the multiplied signals.

3. The antenna receiver according to claim 1, wherein the phase converter includes:
filters for passing the signals from the signal interference remover through preset bands, respectively,
amplifiers for amplifying the signals received from the filter by preset gains, respectively; and
signal converters for converting the signals from the amplifier into a plurality of multi-phase signals of different phases.

4. The antenna receiver according to claim 3, wherein the signal converter includes:
a reference signal generator for generating a reference signal;
a phase shifter for shifting the reference signal from the reference signal generator by different phases to generate a plurality of reference signals of the different phases;
a gain controller for controlling gains of the reference signals received from the phase shifter; and
an adder for adding the reference signals from the gain controller respectively with the receipt signals from the amplifier.

5. The antenna receiver according to claim 1, wherein the signal converter includes:
a reference signal generator for generating a reference signal;
a phase shifter for shifting the reference signal from the reference signal generator by different phases to generate first to fourth reference signals of the different phases;
a gain controller for controlling the first to fourth reference signals received from the phase shifter by different gains; and
an adder for adding the first to fourth reference signals received from the gain controller with respective first to fourth receipt signals received from the amplifier, in which the receipt signals are divided respectively, to generate first to fourth phase signals and providing a plurality of multi-phase signals including the first to fourth phase signals.

6. The antenna receiver according to claim 5, wherein the signal detector includes:
a squarer for squaring the first to fourth phase signals of the multi-phase signals from the signal converter;
a base filter for passing the first to fourth phase signals of the multi-phase signals from the squarer through preset baseband signal bandwidths; and
an adder for adding the first and second phase signals of the multi-phase signals received from the baseband filter to produce an I receipt signal and adding the third and fourth phase signals of the multi-phase signals received from the baseband filter to produce a Q receipt signal.
